(19) United States
(12) Patent Application Publication
(10) Pub. No.: US 2024/0260027 A1
(43) Pub. Date: Aug. 1, 2024

(54) UPLINK CONTROL INFORMATION (UCI) MULTIPLEXING FOR MULTI-TRANSMISSION-RECEPTION POINT (M-TRP) OPERATIONS

(71) Applicant: Intel Corporation, Santa Clara, CA (US)

(72) Inventors: Dong Han, Sunnyvale, CA (US); Bishwarup Mondal, San Ramon, CA (US); Avik Sengupta, San Jose, CA (US); Gang Xiong, Beaverton, OR (US); Alexei Davydov, Nizhny Novgorod (RU)

(21) Appl. No.: 18/290,035

(22) PCT Filed: Sep. 20, 2022
(86) PCT No.: PCT/US2022/044082

§ 371 Date: Nov. 9, 2023

Related U.S. Application Data
(60) Provisional application No. 63/248,302, filed on Sep. 24, 2021.
(60) Provisional application No. 63/249,473, filed on Sep. 28, 2021.

(51) Int. Cl. H04W 72/1268; H04L 1/08; H04L 5/00; H04W 72/21

(52) U.S. Cl. CPC H04W 72/1268; H04L 1/08; H04L 5/0035; H04W 72/21

(57) ABSTRACT

A user equipment (UE configured for multi-Transmission-Reception Point (M-TRP) operation in a fifth-generation (5G) new radio (NR) network with DCI activated PUCCH repetition with TX beam cycling may multiplex UCI on a scheduled PUSCH transmission to a first TRP, multiplex the UCI on a scheduled PUSCH transmission to a second TRP and drop repetitions of the PUCCH when a first repetition of the PUCCH overlaps the scheduled PUSCH transmission to the first TRP and the second repetition of the PUCCH overlaps with a scheduled PUSCH transmission to the second TRP. For multiplexing the UCI and dropping the PUCCH repetitions, a timeline condition may also need to be satisfied.

### PRIORITY CLAIMS

This application claims priority to U.S. Provisional Patent Application Ser. No. 63/248,302, filed Sep. 24, 2021 [reference number AD9083-Z], and U.S. Provisional Patent Application Ser. No. 63/249,473, filed Sep. 28, 2021 [reference number AD9084-Z], which are incorporated herein by reference in their entireties.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks. Some embodiments pertain to multi-transmission-reception point (M-TRP) operation.

### BACKGROUND

Mobile communications Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services.

Such diverse multi-dimensional requirements are driven by different services and applications. In general, NR will evolve based on 3GPP LTE-Advanced with additional potential new Radio Access Technologies (RATs) to enrich people lives with better, simple and seamless wireless connectivity solutions. NR will enable everything connected by wireless and deliver fast, rich contents and services.

For 5G systems, high frequency band communications have attracted significant attention from the industry, since they can provide wider bandwidths to support future integrated communication systems. Beam forming is a critical technology for the implementation of high frequency band communications due to the fact that the beam forming gain can compensate the severe path loss caused by atmospheric attenuation, improve the signal-to-noise ratios (SNR), and enlarge the coverage area. By aligning the transmission beams to the target UE, radiated energy is focused for higher energy efficiency and mutual UE interference is suppressed.

One issue with 5G NR communication, particularly for high frequency band communications, is efficient use of channel resources for multi-transmission-reception point (M-TRP) operation. This is particularly an issue with physical uplink control channel (PUCCH) repetition and physical uplink shared channel (PUSCH) repetition.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates transmission-reception point (TRP) operation, in accordance with some embodiments.

FIG. 3A illustrates overlapping between multi-slot PUCCH and multi-slot PUSCH, in accordance with some embodiments.

FIG. 3B illustrates uplink control information (UCI) multiplexing for M-TRP operations, in accordance with some embodiments.

FIG. 3C illustrates UCI and A-CSI multiplexing for M-TRP operations, in accordance with some embodiments.

FIG. 3D illustrates UCI multiplexing for single-TRP PUCCH transmission and M-TRP PUSCH repetition for M-TRP operations, in accordance with some embodiments.

FIG. 3E illustrates UCI and a-periodic channel state information (A-CSI) multiplexing for single-TRP PUCCH transmission and M-TRP PUSCH repetition for M-TRP operations, in accordance with some embodiments.

FIG. 4 illustrates a block diagram of a communication device such as an evolved Node-B (eNB), a new generation Node-B (gNB), or user equipment (UE), in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for multi-Transmission-Reception Point (M-TRP) operation in a fifth-generation (5G) new radio (NR) network with downlink control information (DCI) activated physical uplink control channel (PUCCH) repetition with transmit (TX) beam cycling. In these embodiments, the UE may multiplex uplink control information (UCI) on a scheduled physical uplink shared channel (PUSCH) transmission to a first TRP, may multiplex the UCI on a scheduled PUSCH transmission to a second TRP, and may drop repetitions of the PUCCH, when a first repetition of the PUCCH overlaps the scheduled PUSCH transmission to the first TRP and the second repetition of the PUCCH overlaps with a scheduled PUSCH transmission to the second TRP. For multiplexing the UCI and dropping the PUCCH repetitions, a timeline condition may also need to be satisfied. These embodiments, as well as others, are described in more detail below.

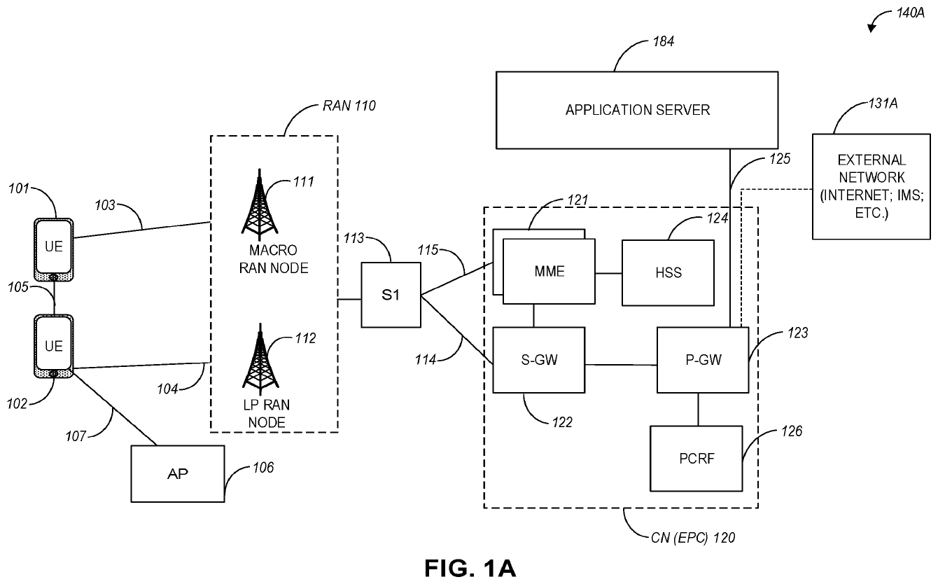

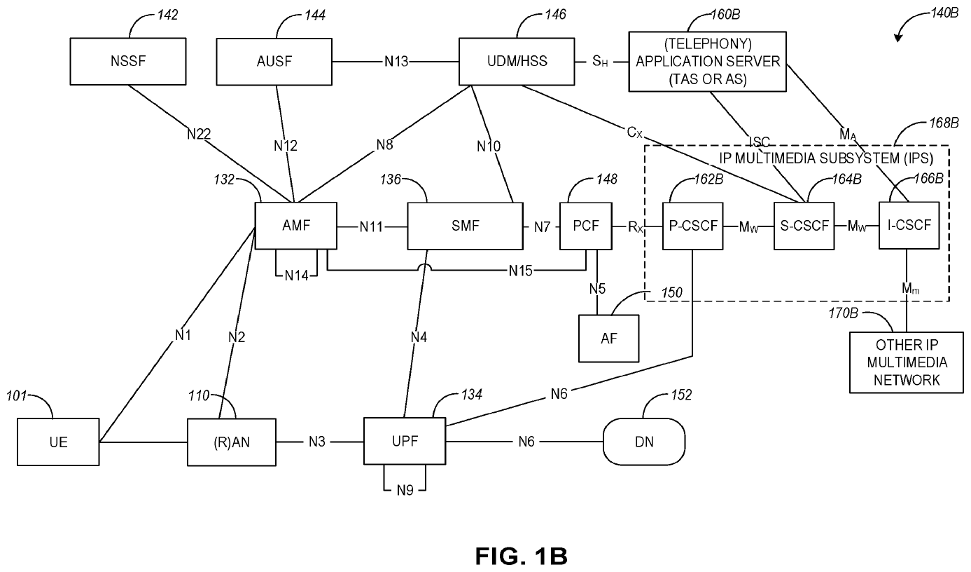

FIG. 1A illustrates an architecture of a network in accordance with some embodiments. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHZ, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UEs 101 and 102 can comprise an Internet-of-Things (IoT) UE or a Cellular IoT (CIoT) UE, which can comprise a network access layer designed for low-power IoT applications utilizing short-lived UE connections. In some embodiments, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

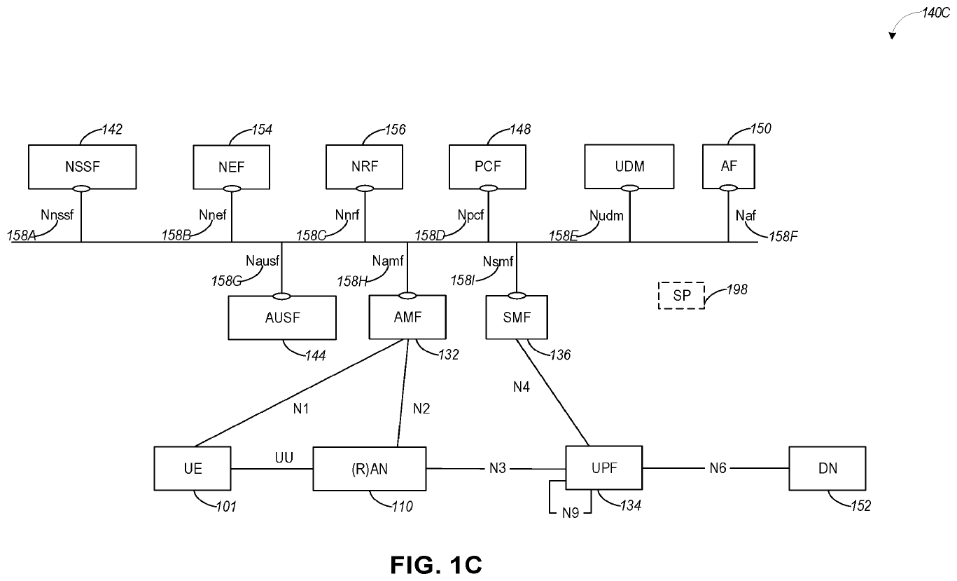

FIG. 2 illustrates transmission-reception point (TRP) operation, in accordance with some embodiments. FIG. 2 illustrates transmission of a physical downlink shared channel (PDSCH) from more than one transmission-reception point (TRP), in accordance with some embodiments. TRPs may also be configured for transmission of PDCCHs. The UE may also be configured for transmission of PUCCHs and PUSCHs to more than on TRP. These embodiments are described in more detail below.

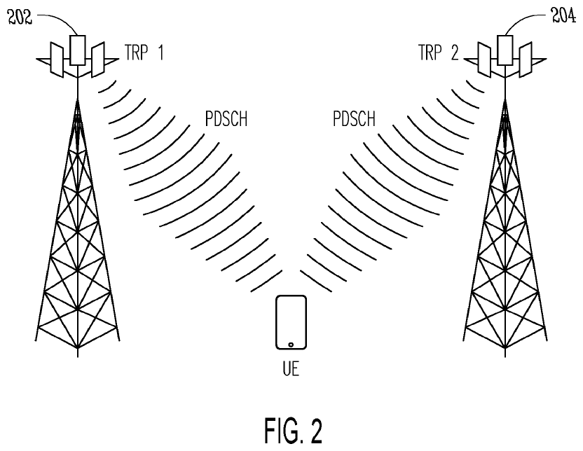

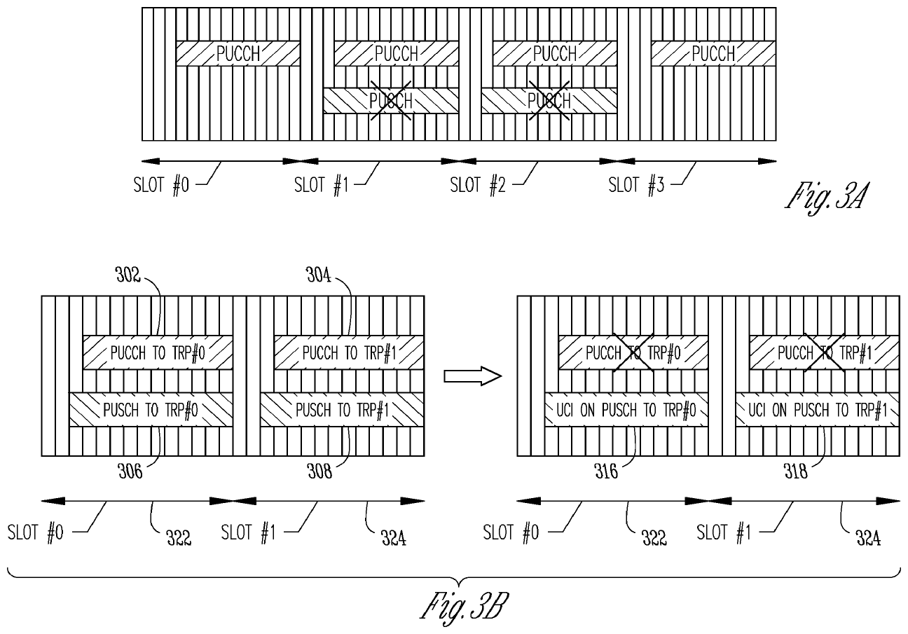

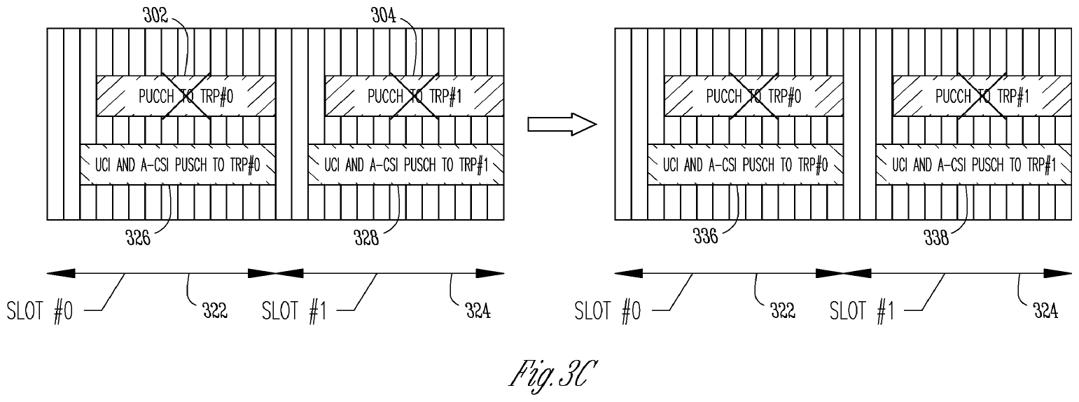

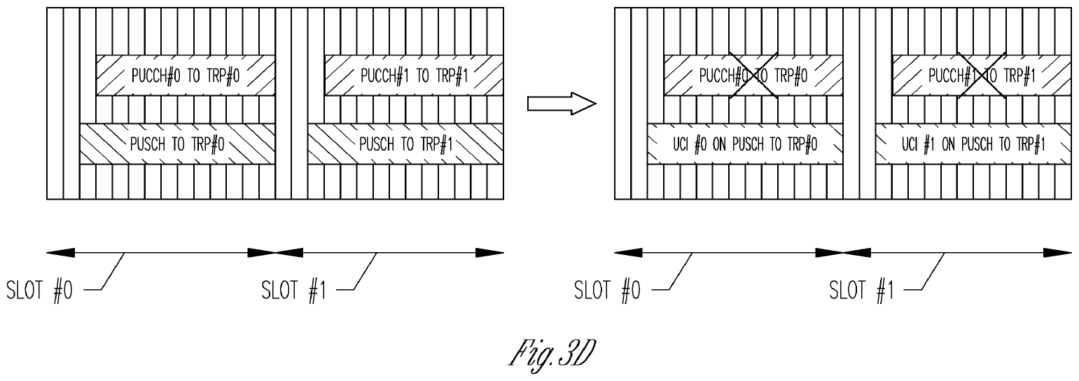

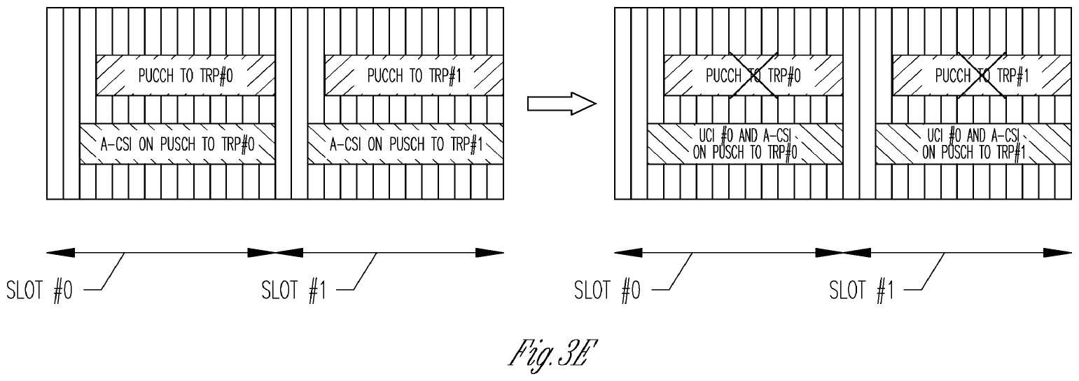

FIG. 3A illustrates overlapping between multi-slot PUCCH and multi-slot PUSCH, in accordance with some embodiments.

FIG. 3B illustrates UCI multiplexing for M-TRP operations, in accordance with some embodiments.

FIG. 3C illustrates UCI and A-CSI multiplexing for M-TRP operations, in accordance with some embodiments.

FIG. 3D illustrates UCI multiplexing for single-TRP PUCCH transmission and M-TRP PUSCH repetition for M-TRP operations, in accordance with some embodiments.

FIG. 3E illustrates UCI and A-CSI multiplexing for single-TRP PUCCH transmission and M-TRP PUSCH repetition for M-TRP operations, in accordance with some embodiments.

In NR, short physical uplink control channel (PUCCH) (PUCCH format 0 and 2) can span 1 or 2 symbols and long PUCCH (PUCCH format 1, 3 and 4) can span from 4 to 14 symbols within a slot. Further, in Rel-15, long PUCCH may span multiple slots to further enhance the coverage. Note that as defined in NR, uplink control information (UCI) can be carried by PUCCH or physical uplink shared channel (PUSCH). In particular, UCI may include scheduling request (SR), hybrid automatic repeat request-acknowledgement (HARQ-ACK) feedback, channel state information (CSI) report, e.g., channel quality indicator (CQI), pre-coding matrix indicator (PMI), CSI resource indicator (CRI) and rank indicator (RI) and/or beam related information (e.g., L1-RSRP (layer 1—reference signal received power)).

Further, when single slot PUCCH overlaps with multi-slot PUSCH repetition in a slot, if the timeline requirement is met for the overlapped slot, UCI is multiplexed on PUSCH in the overlapped slot and the single-slot PUCCH is dropped. In addition, when multi-slot PUCCH repetition overlaps with single/multi-slot PUSCH repetition in time, if the timeline requirement within overlapping slots is met, PUSCH is dropped without deferral in overlapping slots.

FIG. 3A illustrates one example of overlapping between multi-slot PUCCH and multi-slot PUSCH. In the example, 4 and 2 repetitions are employed for the PUCCH and PUSCH transmission, respectively. In addition, PUSCH repetitions overlap with PUCCH repetitions in slot #1 and slot #2. If the timeline requirement is met, PUSCH repetitions in slot #1 and slot #2 are dropped.

For M-TRP operations, different transmit beams can be applied for the PUCCH and PUSCH repetitions to exploit the benefits of spatial diversity. In particular, beam mapping pattern between repetitions and TRPs can be either cyclic mapping or sequential mapping. Note that beam cycling can be applied for PUSCH repetition type A and type B. For PUSCH repetition B, different beams are applied for the nominal repetitions.

Note that when beam cycling is applied for PUCCH and PUSCH repetitions for M-TRP operations, and when PUCCH and PUSCH repetitions overlap in time, PUSCH repetitions may not be dropped so as to avoid the resource waste, especially consider the TDD configurations with DL heavy pattern. In this case, certain mechanisms may need to be considered to allow UCI multiplexing on PUSCH repetitions.

Embodiments disclosed herein propose mechanisms for UCI multiplexing for M-TRP operation. UCI multiplexing for M-TRP operation As mentioned above, for M-TRP operations, different transmit beams can be applied for the PUCCH and PUSCH repetitions to exploit the benefits of spatial diversity. In particular, beam mapping pattern between repetitions and TRPs can be either cyclic mapping or sequential mapping.

Note that beam cycling can be applied for PUSCH repetition type A and type B. For PUSCH repetition B, different beams are applied for the nominal repetitions. Note that when beam cycling is applied for PUCCH and PUSCH repetitions for M-TRP operations, and when PUCCH and PUSCH repetitions overlap in time, PUSCH repetitions may not be dropped so as to avoid the resource waste, especially consider the TDD configurations with DL heavy pattern. In this case, certain mechanisms may need to be considered to allow UCI multiplexing on PUSCH repetitions.

Embodiments of UCI multiplexing for M-TRP operation are provided as follows: In one embodiment, for M-TRP operation, when different Tx beams are applied for two PUCCH repetitions, and when different Tx beams are applied for two or more than two PUSCH repetitions, and if a PUCCH repetition targeted to a TRP overlaps with a PUSCH targeted to the same TRP in a slot, and if the timeline requirement for the overlapped slot is satisfied, UCI carried by PUCCH is multiplexed on the PUSCH in the overlapped slot and the PUCCH is dropped.

FIG. 3B illustrates one example of UCI multiplexing for M-TRP operation. In the example, PUCCH repetition to TRP #0 overlaps with PUSCH repetition to TRP #0 in slot #0, and PUCCH repetition to TRP #1 overlaps with PUSCH repetition to TRP #1 in slot #1. In this case, UCI carried by PUCCH is multiplexed on PUSCH to TRP #0 in slot #0 and UCI carried by PUCCH is multiplexed on PUSCH to TRP #1 in slot #1. In addition, PUCCH repetitions to TRP #0 and TRP #1 are dropped.

In another embodiment, for M-TRP operation, when different Tx beams are applied for two PUCCH repetitions, and when different Tx beams are applied for two PUSCH repetitions carrying aperiodic channel state information (A-CSI), and if a PUCCH repetition targeted to a TRP overlaps with a PUSCH targeted to the same TRP in a slot, and if the timeline requirement for the overlapped slot is satisfied, UCI carried by PUCCH and A-CSI multiplexed on the PUSCH in the overlapped slot and the PUCCH is dropped. Note that same mechanism can also be applied for the case when semi-persistent CSI (SP-CSI) on PUSCH overlaps with PUCCH in case of M-TRP operation.

FIG. 3C illustrates one example of UCI and A-CSI multiplexing for M-TRP operation. In the example, PUCCH repetition to TRP #0 overlaps with PUSCH repetition to TRP #0 in slot #0, and PUCCH repetition to TRP #1 overlaps with PUSCH repetition to TRP #1 in slot #1. In this case, UCI carried by PUCCH and A-CSI are multiplexed on PUSCH to TRP #0 in slot #0 and UCI carried by PUCCH and A-CSI are multiplexed on PUSCH to TRP #1 in slot #1. In addition, PUCCH repetitions to TRP #0 and TRP #1 are dropped. Note that same mechanism can also be applied for the case when semi-persistent CSI (SP-CSI) on PUSCH overlaps with PUCCH in case of M-TRP operation.

In another embodiment, for single-TRP PUCCH transmission and M-TRP PUSCH repetition, when different Tx beams are applied for two PUCCH transmissions carrying different UCIs, and when different Tx beams are applied for two or more than two PUSCH repetitions, and if a PUCCH transmission targeted to a TRP overlaps with a PUSCH targeted to the same TRP in a slot, and if the timeline requirement for the overlapped slot is satisfied, UCI carried by PUCCH is multiplexed on the PUSCH in the overlapped slot and the PUCCH is dropped.

FIG. 3D illustrates one example of two different UCIs (in two single-TRP PUCCHs, respectively) multiplexing for single-TRP PUCCH transmissions and M-TRP PUSCH repetitions. In the example, PUCCH #0 carrying UCI #0 to TRP #0 overlaps with PUSCH repetition to TRP #0 in slot #0, and PUCCH #1 carrying UCI #1 to TRP #1 overlaps with PUSCH repetition to TRP #1 in slot #1. In this case, UCI #0 carried by PUCCH #0 is multiplexed on PUSCH to TRP #0 in slot #0 and UCI #1 carried by PUCCH #1 is multiplexed on PUSCH to TRP #1 in slot #1. In addition, PUCCH #0 and #1 to TRP #0 and TRP #1, respectively are dropped.

In another embodiment, for single-TRP PUCCH transmission and M-TRP PUSCH repetition, when different Tx beams are applied for two PUCCH transmissions carrying different UCIs, and when different Tx beams are applied for two PUSCH repetitions carrying aperiodic channel state information (A-CSI), and if a PUCCH transmission targeted to a TRP overlaps with a PUSCH targeted to the same TRP in a slot, and if the timeline requirement for the overlapped slot is satisfied, UCI carried by PUCCH and A-CSI multiplexed on the PUSCH in the overlapped slot and the PUCCH is dropped.

FIG. 3E illustrates one example of two different UCIs (in two single-TRP PUCCHs, respectively) and A-CSI multiplexing for single-TRP PUCCH transmissions and M-TRP PUSCH repetitions. In the example, PUCCH #0 carrying UCI #0 to TRP #0 overlaps with PUSCH repetition to TRP #0 in slot #0, and PUCCH #1 carrying UCI #1 to TRP #1 overlaps with PUSCH repetition to TRP #1 in slot #1. In this case, UCI #0 carried by PUCCH #0 and A-CSI are multiplexed on PUSCH to TRP #0 in slot #0 and UCI #1 carried by PUCCH #1 and A-CSI are multiplexed on PUSCH to TRP #1 in slot #1. In addition, PUCCH #0 and #1 to TRP #0 and TRP #1, respectively, are dropped.

Note that the above embodiments can be straightforwardly extended to the case when single-TRP PUSCH transmission overlaps with M-TRP PUCCH repetitions. The PUSCH may be used to carry A-CSI or SP-CSI. Note that same mechanism can also be applied for the case when semi-persistent CSI (SP-CSI) on PUSCH overlaps with PUCCH in case of single-TRP PUCCH transmission and M-TRP PUSCH repetition. Note that the above embodiments can be applied for the case for PUSCH repetition type A and type B or dynamic grant based PUSCH (DG-PUSCH) and configured grant PUSCH (CG-PUSCH).

In another embodiment, the beam of a PUSCH is indicated in the sounding reference signal (SRS) resource indicator (SRI) field in the DCI. For PUCCH, DCI indicates the PUCCH resource indicator, which corresponds to a PUCCH resource with a certain pucch-ResourceId. This pucch-ResourceId is associated with a PUCCH-SpatialRelationInfo via MAC CE. And this PUCCHSpatialRelationInfo can be SSB-index, CSI-RS-index, or SRS, indicated in RRC. In general, the UE can determine whether a PUSCH and a PUCCH are transmitted towards the same TRP by the spatial relation between SRS and other reference signals such as CSI-RS and SSB, as shown in the following SRS-SpatialRelationInfo structure in SRS-Resource in RRC configuration.

| | |
|---|---|
| SRS-SpatialRelationInfo ::= | SEQUENCE { |
| servingCellId | ServCellIndex OPTIONAL, -- Need R |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

In some embodiments, the timeline requirement may be the timeline conditions described in 3GPP TS 38.213 section 9.2.5, although the scope of the embodiments is not limited in this respect. 3GPP TS 38.213 v16.6.0 (Jun. 30, 2021) is incorporated herein by reference. 3GPP TS 38.214 v16.6.0 (Jun. 30, 2021) is incorporated herein by reference.

For SP-CSI report on mTRP PUSCH repetition Type A and B activated by a DCI, support the use of a similar mechanism to A-CSI multiplexing on M-TRP PUSCH without a TB, which includes the following,
When SP-CSI multiplexed on M-TRP PUSCH, SP-CSI multiplexed on the two repetitions associated with the two TRPs, and the number of repetitions is always assumed to be 2, regardless of the value indicated.
For mTRP PUSCH repetition Type A, or for the first PUSCH after activation for PUSCH repetition Type B, reuse similar conditions to support SP-CSI multiplexing on M-TRP PUSCH as defined in A-CSI multiplexing on M-TRP PUSCH, i.e.,
   The UE is expected to follow the above operation for transmitting SP-CSI on two PUSCH repetitions only if
      For the first PUSCH after activation for PUSCH repetition Type B, the first and second nominal repetitions are expected to be the same as the first and second actual repetitions, respectively (no segmentation).
      For PUSCH repetition Type A and B, UCIs other than the SP-CSI are not multiplexed on any of the two PUSCH repetitions.
   When the UE does not follow the above operation, UE transmits SP-CSI only on the first PUSCH repetition similar to Rel. 15/16.
For subsequent PUSCHs after activation (without corresponding PDCCH) for PUSCH repetition Type B, use the following criteria,
   If the first/second nominal repetition is not the same as the first/second actual repetition, the first/second nominal repetition is dropped
      If one of the first or second nominal repetitions is not dropped, SP-CSI is multiplexed on that repetition
   Else (the first and second nominal repetitions are the same as the first and second actual repetitions)
      If UCIs other than the SP-CSI are not multiplexed on any of the two PUSCH repetitions, SP-CSI is multiplexed on both repetitions.
      Otherwise, UE transmits SP-CSI only on the first PUSCH repetition similar to Rel. 15/16 (and the second repetition is dropped).

For s-DCI based multi-TRP PUSCH repetition Type A and B, support transmitting A-CSI on the first PUSCH repetition corresponding to the first beam and the first PUSCH repetition corresponding to the second beam when there is no TB carried in the PUSCH.

The UE assumes that the number of repetitions is 2 regardless of the indicated number of repetitions.
The UE is expected to follow the above operation for transmitting A-CSI on two PUSCH repetitions only if
   For PUSCH repetition Type B, the first and second nominal repetitions are expected to be the same as the first and second actual repetitions, respectively (no segmentation).
   For PUSCH repetition Type A and B, UCIs other than the A-CSI are not multiplexed on any of the two PUSCH repetitions.
When the UE does not follow the above operation, UE transmits A-CSI only on the first PUSCH repetition similar to Rel. 15/16.
Note: The scheduling offset for the first A-CSI should meet the Z and Z′ requirement.

Some embodiments are directed to a user equipment (UE) configured for multi-Transmission-Reception Point (M-TRP) operation in a fifth-generation (5G) new radio (NR) or 6G network. In these embodiments, the UE may be configured to decode a downlink control information (DCI) to activate physical uplink control channel (PUCCH) repetition with transmit (TX) beam cycling. As illustrated in FIG. 3B, the PUCCH repetition with TX beam cycling may comprise a first repetition 302 of a PUCCH for carrying uplink control information (UCI) for transmission in a first slot 322 (i.e., slot #0) (see FIG. 3B) to a first TRP 202 (see FIG. 2) using a first TX beam, and a second repetition 304 of the PUCCH for carrying the UCI for transmission in a second slot 324 (i.e., slot #1) to a second TRP 204 (see FIG. 2) using a second TX beam.

In these embodiments, the UE may be configured to determine if the first repetition 302 of the PUCCH overlaps in the first slot 322 with a scheduled physical uplink shared channel (PUSCH) transmission 306 to the first TRP in the first slot and if the second repetition 304 of the PUCCH overlaps in the second slot 324 with a scheduled PUSCH transmission 308 to the second TRP. In these embodiments, when the first repetition of the PUCCH overlaps in the first slot with the scheduled PUSCH transmission to the first TRP in the first slot and when the second repetition of the PUCCH overlaps in the second slot with the scheduled PUSCH transmission to the second TRP, the UE may be configured to multiplex the UCI on the scheduled PUSCH transmission 316 in the first slot for transmission to the first TRP using the first TX beam. The UE may also multiplex the UCI on the scheduled PUSCH transmission 318 in the second slot for transmission to the second TRP using the second TX beam. In these embodiments, the UE may also be configured to drop the first and second repetitions of the PUCCH (i.e., refrain from transmitting the first repetition of the PUCCH in the first slot and refrain from transmitting the second repetition of the PUCCH in the second slot).

In some embodiments, the UE may determine if a timeline condition is satisfied, at least in part, when a first symbol S₀ of either the first repetition of the PUCCH in the first slot or the PUSCH transmission in the first slot is not before a symbol with a cyclic prefix (CP) starting after a last symbol of a physical downlink shared channel (PDSCH) or physical downlink control channel (PDCCH) reception. In these embodiments, when the timeline condition is satisfied, the UE may multiplex the UCI on the scheduled PUSCH transmission in the first slot for transmission to the first TRP using the first TX beam, multiplex the UCI on the scheduled PUSCH transmission in the second slot for transmission to the second TRP using the second TX beam, and drop the first and second repetitions of the PUCCH.

In some embodiments, the UCI comprises multiple UCI types, the multiple DCI types indicated or activated by a DCI format. In these embodiments, the multiple UCI types may be multiplexed on the PUSCH.

In some embodiments, when the scheduled PUSCH transmission in the first slot and the scheduled PUSCH transmission in the second slot comprise two PUSCH repetitions carrying one of a-periodic channel state information (A-CSI) and semi-persistent CSI (SP-CSI), and when the first repetition 302 of the PUCCH overlaps in the first slot 322 with the scheduled PUSCH transmission 326 to the first TRP in the first slot 322 and when the second repetition 304 of the PUCCH overlaps in the second slot 324 with the scheduled PUSCH 328 transmission to the second TRP, the UE may multiplex the UCI and one of the A-CSI and the SP-CSI on the scheduled PUSCH transmission 336 in the first slot 322 for transmission to the first TRP using the first TX beam, and multiplex the UCI and one of the A-CSI and the SP-CSI on the scheduled PUSCH transmission 338 in the second slot 324 for transmission to the second TRP using the second TX beam. In these embodiments, the UE may also drop the first and second repetitions of the PUCCH. An example of this is illustrated in FIG. 3C.

In some embodiments, the PUSCH repetition may be PUSCH repetition Type A or PUSCH repetition Type B. In these embodiments, the scheduled PUSCH transmission may be one of configured grant PUSCH (CG-PUSCH) transmission and a dynamic grant based PUSCH (DG-PUSCH) transmission. In these embodiments, for PUSCH repetition Type A, each slot contains only one repetition and the time domain for the repetitions of a transport block (TB) is the same in those slots. In PUSCH repetition Type B, the repetitions are carried out in the consecutive mini-slots so one slot may contain more than one repetition of a TB. In a DG transmission, UE sends scheduling request (SR) to the gNB and receives UL grant with resource allocation. In a CG transmission, the UE transmits UL data in the configured resources without the transmission of SR and UL grant so the use of CG transmission reduces latency.

In some embodiments, the UE may determine whether a repetition of a PUCCH and a scheduled PUSCH transmission are to be directionally transmitted towards a same TRP based on a spatial relation between a sounding reference signal (SRS) and one or more other reference signals including at least one of a channel state information reference signal (CSI-RS) and a Synchronization Signal/PBCH Block (SSB). In these embodiments, the TX beam of a PUSCH may be indicated in the sounding reference signal (SRS) resource indicator (SRI) field in the DCI. For the PUCCH, the DCI may indicate a PUCCH resource indicator, which corresponds to a PUCCH resource with a certain pucch-ResourceId. This pucch-ResourceId is associated with a PUCCH-SpatialRelationInfo via MAC CE and the PUCCHSpatialRelationInfo can be SSB-index, CSI-RS-index, or SRS, indicated in RRC signalling.

In some embodiments, the UE may apply transmit beamforming for generating the first TX beam in a direction of the first TRP for the scheduled PUSCH transmission 316 in the first slot. In these embodiments, the UE may also apply transmit beamforming for generating the second TX beam in a direction of the second TRP for the scheduled PUSCH transmission 318 in the second slot. In some embodiments, the UE may utilize two or more antennas for the directional beamforming.

In some embodiments, when the first repetition of the PUCCH does not overlap in the first slot with the scheduled PUSCH transmission and when the second repetition of the PUCCH does not overlap in the second slot with the scheduled PUSCH transmission, the UE may transmit the first and second repetitions of the PUCCH with the UCI to the first and second TRPs, respectfully, and transmit the scheduled PUSCH transmission, to the first and second TRPs respectfully, without the UCI multiplexed thereon.

In some embodiments, when the timeline condition is not satisfied, or when the first repetition of the PUCCH does not overlap in the first slot with the scheduled PUSCH transmission and when the second repetition of the PUCCH does not overlap in the second slot with the scheduled PUSCH transmission, the UE may refrain from multiplexing the UCI on the scheduled PUSCH transmission in the first slot for transmission to the first TRP using the first TX beam, refrain from multiplexing the UCI on the scheduled PUSCH transmission in the second slot for transmission to the second TRP using the second TX beam, and refrain from dropping the first and second repetitions of the PUCCH, although the scope of the embodiments is not limited in this respect.

In some embodiments, for the M-TRP operation, the processing circuitry configures the UE for communicating with Next Generation Radio Access Network (NG-RAN) node (i.e., a gNodeB or gNB) comprising a plurality of spatially-diverse Transmission-Reception Points (TRPs). In some embodiments, PUCCH repetition with TX beam cycling may be DCI activated. In some other embodiments, RRC signalling may configure the UE for the PUCCH repetition with TX beam cycling.

In some embodiments, the UE may encode data for transmission on the scheduled PUSCH transmissions. In some embodiments, the UE may decode data from a PDSCH received from both the first and second TRPs. In some embodiments, memory of the UE may be configured to store the UCI.

Some embodiments are directed to a non-transitory computer-readable storage medium that stores instructions for execution by processing circuitry of a user equipment (UE) configured for multi-Transmission-Reception Point (M-TRP) operation in a fifth-generation (5G) new radio (NR) or 6G network.

Some embodiments are directed to a generated node B (gNB) configured for multi-Transmission-Reception Point (M-TRP) operation in a fifth-generation (5G) new radio (NR) or 6G network. In these embodiments, the gNB may comprise a plurality of spatially-diverse Transmission-Reception Points (TRPs). In these embodiments, the gNB may encode a downlink control information (DCI) for transmission to a user equipment (UE) to activate physical uplink control channel (PUCCH) repetition with transmit (TX) beam cycling by the UE. In these embodiments, the PUCCH repetition with TX beam cycling may comprise a first repetition 302 of a PUCCH for carrying uplink control information (UCI) for transmission in a first slot 322 (i.e., slot #0) (see FIG. 3B) to a first TRP 202 (see FIG. 2) using a first TX beam, and a second repetition 304 of the PUCCH for carrying the UCI for transmission in a second slot 324 (i.e., slot #1) to a second TRP 204 (see FIG. 2) using a second TX beam.

In these embodiments, when the first repetition 302 of the PUCCH overlaps in the first slot 322 with a scheduled physical uplink shared channel (PUSCH) transmission 306 to the first TRP in the first slot and when the second repetition 304 of the PUCCH overlaps in the second slot 324 with a scheduled PUSCH transmission 308 to the second TRP, the gNB may decode the scheduled PUSCH transmission 316 multiplexed with the UCI in the first slot received from the UE at the first TRP. The gNB may also decode the scheduled PUSCH transmission 318 multiplexed with the UCI in the second slot received from the UE at the second TRP. In these embodiments, the gNB does not expect to receive the UCI on the first and second repetitions of the PUCCH.

In some of these embodiments, the scheduled PUSCH transmission in the first slot and the scheduled PUSCH transmission in the second slot comprise two PUSCH repetitions carrying one of a-periodic channel state information (A-CSI) and semi-persistent CSI (SP-CSI). In some of these embodiments, the PUSCH repetition is one of PUSCH repetition Type A and PUSCH repetition Type B. In some of these embodiments, the scheduled PUSCH transmission is one of configured grant PUSCH (CG-PUSCH) transmission and a dynamic grant based PUSCH (DG-PUSCH) transmission.

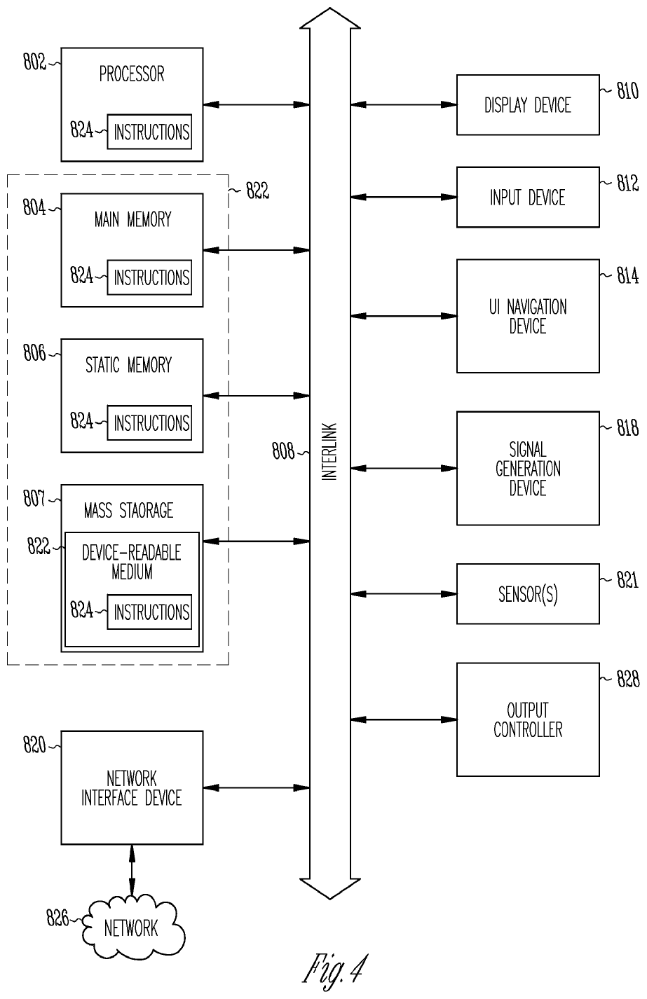

FIG. 4 illustrates a block diagram of a communication device such as an evolved Node-B (eNB), a new generation Node-B (gNB), or user equipment (UE), in accordance with some embodiments. In alternative aspects, the communication device 800 may operate as a standalone device or may be connected (e.g., networked) to other communication devices.

Circuitry (e.g., processing circuitry) is a collection of circuits implemented in tangible entities of the device 800 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 800 follow.

In some aspects, the device 800 may operate as a standalone device or may be connected (e.g., networked) to other devices. In a networked deployment, the communication device 800 may operate in the capacity of a server communication device, a client communication device, or both in server-client network environments. In an example, the communication device 800 may act as a peer communication device in peer-to-peer (P2P) (or other distributed) network environment. The communication device 800 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 800 may include a hardware processor 802 (e.g., a central processing unit (CPU), a graphics processing unit (GPU), a hardware processor core, or any combination thereof), a main memory 804, a static memory 806, and mass storage 807 (e.g., hard drive, tape drive, flash storage, or other block or storage devices), some or all of which may communicate with each other via an interlink (e.g., bus) 808.

The communication device 800 may further include a display device 810, an alphanumeric input device 812 (e.g., a keyboard), and a user interface (UI) navigation device 814 (e.g., a mouse). In an example, the display device 810, input device 812, and UI navigation device 814 may be a touchscreen display. The communication device 800 may additionally include a signal generation device 818 (e.g., a speaker), a network interface device 820, and one or more sensors 821, such as a global positioning system (GPS) sensor, compass, accelerometer, or another sensor. The communication device 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 807 may include a communication device-readable medium 822, on which is stored one or more sets of data structures or instructions 824 (e.g., software) embodying or utilized by any one or more of the techniques or functions described herein. In some aspects, registers of the processor 802, the main memory 804, the static memory 806, and/or the mass storage 807 may be, or include (completely or at least partially), the device-readable medium 822, on which is stored the one or more sets of data structures or instructions 824, embodying or utilized by any one or more of the techniques or functions described herein. In an example, one or any combination of the hardware processor 802, the main memory 804, the static memory 806, or the mass storage 816 may constitute the device-readable medium 822.

As used herein, the term “device-readable medium” is interchangeable with “computer-readable medium” or “machine-readable medium”. While the communication device-readable medium 822 is illustrated as a single medium, the term “communication device-readable medium” may include a single medium or multiple media (e.g., a centralized or distributed database, and/or associated caches and servers) configured to store the one or more instructions 824. The term “communication device-readable medium” is inclusive of the terms “machine-readable medium” or “computer-readable medium”, and may include any medium that is capable of storing, encoding, or carrying instructions (e.g., instructions 824) for execution by the communication device 800 and that cause the communication device 800 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 824 may further be transmitted or received over a communications network 826 using a transmission medium via the network interface device 820 utilizing any one of a number of transfer protocols. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input-multiple-output (SIMO), MIMO, or multiple-input-single-output (MISO) techniques. In some examples, the network interface device 820 may wirelessly communicate using Multiple User MIMO techniques.

### EXAMPLES

Example 1 is a system and method of wireless communication for a fifth generation (5G) or new radio (NR) system: Determined, by UE, a same Tx beam for the transmission of a physical uplink control channel (PUCCH) and a physical uplink shared channel (PUSCH) targeted to a transmit and receive point (TRP) Determined, by UE, that the PUCCH and PUSCH overlap at least one symbol in a slot. This example includes multiplexing, by UE, the uplink control information (UCI) on the PUSCH, and dropping, by UE, the PUCCH transmission.

Example 2. The method of example 1, wherein when different Tx beams are applied for two PUCCH repetitions, and when different Tx beams are applied for two or more than two PUSCH repetitions, and if a PUCCH repetition targeted to a TRP overlaps with a PUSCH targeted to the same TRP in a slot, and if the timeline requirement for the overlapped slot is satisfied, UCI carried by PUCCH is multiplexed on the PUSCH in the overlapped slot and the PUCCH is dropped

Example 3. The method of example 1, wherein for multi-TRP operation, when different Tx beams are applied for two PUCCH repetitions, and when different Tx beams are applied for two PUSCH repetitions carrying aperiodic channel state information (A-CSI), and if a PUCCH repetition targeted to a TRP overlaps with a PUSCH targeted to the same TRP in a slot, and if the timeline requirement for the overlapped slot is satisfied, UCI carried by PUCCH and A-CSI multiplexed on the PUSCH in the overlapped slot and the PUCCH is dropped.

Example 4. The method of example 1, wherein for single-TRP PUCCH transmission and multi-TRP PUSCH repetition, when different Tx beams are applied for two PUCCH transmissions carrying different UCIs, and when different Tx beams are applied for two or more than two PUSCH repetitions, and if a PUCCH transmission targeted to a TRP overlaps with a PUSCH targeted to the same TRP in a slot, and if the timeline requirement for the overlapped slot is satisfied, UCI carried by PUCCH is multiplexed on the PUSCH in the overlapped slot and the PUCCH is dropped.

Example 5. The method of example 1, wherein for single-TRP PUCCH transmission and multi-TRP PUSCH repetition, when different Tx beams are applied for two PUCCH transmissions carrying different UCIs, and when different Tx beams are applied for two PUSCH repetitions carrying aperiodic channel state information (A-CSI), and if a PUCCH transmission targeted to a TRP overlaps with a PUSCH targeted to the same TRP in a slot, and if the timeline requirement for the overlapped slot is satisfied, UCI carried by PUCCH and A-CSI multiplexed on the PUSCH in the overlapped slot and the PUCCH is dropped.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1.-20. (canceled)

21. An apparatus for a user equipment (UE) configured for operation in a fifth-generation (5G) new radio (NR) network, the apparatus comprising: processing circuitry; and memory, wherein when the UE supports multi-Transmission-Reception Point (M-TRP) physical uplink control channel (PUCCH) repetition, the processing circuitry is configured to:
decode a downlink control information (DCI), the DCI to activate M-TRP PUCCH repetition with transmit (TX) beam cycling,
wherein the M-TRP PUCCH repetition with TX beam cycling comprises:
a first repetition of a PUCCH for carrying uplink control information (UCI) for transmission in a first slot to a first TRP using a first spatial setting; and
a second repetition of the PUCCH for carrying the UCI for transmission in a second slot to a second TRP using a second spatial setting,
wherein for UCI of different UCI types when the UE is configured to multiplex different UCI types in one PUCCH and when the first repetition of the PUCCH overlaps in the first slot with a scheduled physical uplink shared channel (PUSCH) transmission to the first TRP in the first slot, the processing circuitry is further configured to:
determine if timeline conditions are satisfied with respect to a first symbol of the first repetition of the PUCCH and the scheduled PUSCH in the first slot,
wherein when the timeline conditions are satisfied, the processing circuitry is configured to:
multiplex the UCI of the different UCI types on the scheduled PUSCH transmission in the first slot for transmission to the first TRP using the first spatial settings; and
multiplex the UCI of the different UCI types on the scheduled PUSCH transmission in the second slot for transmission to the second TRP using the second spatial settings.

22. The apparatus of claim 21, wherein to determine if the timeline conditions are satisfied, the processing circuitry is further configured to:
determine if the first symbol of the first repetition of the PUCCH and the scheduled PUSCH in the first slot is not before a symbol with a cyclic prefix (CP) starting after a last symbol of a physical downlink control channel (PDCCH) reception.

23. The apparatus of claim 22, wherein when the timeline conditions are satisfied and the UCI of the different UCI types is multiplexed on the scheduled PUSCH transmission in the first slot and multiplexed on the scheduled PUSCH transmission in the second slot, the processing circuitry is configured to cause the UE to refrain from transmitting the first and second repetitions of the PUCCH.

24. The apparatus of claim 22, wherein the first spatial settings correspond to a first TX beam transmitted by the UE to the first TRP and the second spatial settings correspond to a second TX beam transmitted by the UE to the second TRP.

25. The apparatus of claim 22, wherein the scheduled PUSCH transmission in the first slot and the scheduled PUSCH transmission in the second slot comprise two PUSCH repetitions carrying aperiodic channel state information (A-CSI).

26. The apparatus of claim 25, wherein the two PUSCH repetitions comprise M-TRP PUSCH repetition Type A.

27. The apparatus of claim 22, wherein when the UE is configured to multiplex the different UCI types in one PUCCH and when the second repetition of the PUCCH overlaps in the second slot with a scheduled PUSCH transmission in the second slot the processing circuitry is further configured to:
determine if the timeline conditions are also satisfied with respect to a first symbol of the second repetition of the PUCCH and the scheduled PUSCH in the second slot.

28. The apparatus of claim 27, wherein when the timeline conditions are also satisfied, the processing circuitry is configured to:
multiplex the UCI of the different UCI types on the scheduled PUSCH transmission in the first slot for transmission to the first TRP using the first spatial settings; and
multiplex the UCI of the different UCI types on the scheduled PUSCH transmission in the second slot for transmission to the second TRP using the second spatial settings.

29. The apparatus of claim 22, wherein when the UE is configured to multiplex different UCI types in one PUCCH and when the first repetition of the PUCCH does not overlap in the first slot with the scheduled PUSCH transmission in the first slot and the second repetition of the PUCCH does not overlap in the second slot with the scheduled PUSCH transmission in the second slot, the processing circuitry is configured to:
multiplex the UCI of the different UCI types on the first and second repetitions of the PUCCH for transmission, respectfully, in the first and second slots; and
configure the UE to transmit the scheduled PUSCH transmissions in the first and second slots without the UCI of the different UCI types multiplexed thereon.

30. The apparatus of claim 22, wherein when the UE is configured to multiplex different UCI types in one PUCCH and when the first repetition of the PUCCH does not overlap in the first slot with the scheduled PUSCH transmission in the first slot and the second repetition of the PUCCH does not overlap in the second slot with the scheduled PUSCH transmission in the second slot, the processing circuitry is configured to:
refrain from multiplexing the UCI of the different UCI types on the scheduled PUSCH transmission in the first slot for transmission to the first TRP using the first spatial settings; and refrain from multiplexing the UCI of the different UCI types on the scheduled PUSCH transmission in the second slot for transmission to the second TRP using the second spatial settings.

31. A non-transitory computer-readable storage medium that stores instructions for execution by processing circuitry of a user equipment (UE) configured for operation in a fifth-generation (5G) new radio (NR) network, wherein when the UE supports multi-Transmission-Reception Point (M-TRP) physical uplink control channel (PUCCH) repetition, the processing circuitry is configured to:
decode a downlink control information (DCI), the DCI to activate M-TRP PUCCH repetition with transmit (TX) beam cycling,
wherein the M-TRP PUCCH repetition with TX beam cycling comprises:
a first repetition of a PUCCH for carrying uplink control information (UCI) for transmission in a first slot to a first TRP using a first spatial setting; and
a second repetition of the PUCCH for carrying the UCI for transmission in a second slot to a second TRP using a second spatial setting,
wherein for UCI of different UCI types when the UE is configured to multiplex different UCI types in one PUCCH and when the first repetition of the PUCCH overlaps in the first slot with a scheduled physical uplink shared channel (PUSCH) transmission to the first TRP in the first slot, the processing circuitry is further configured to:
determine if timeline conditions are satisfied with respect to a first symbol of the first repetition of the PUCCH and the scheduled PUSCH in the first slot,
wherein when the timeline conditions are satisfied, the processing circuitry is configured to:
multiplex the UCI of the different UCI types on the scheduled PUSCH transmission in the first slot for transmission to the first TRP using the first spatial settings; and
multiplex the UCI of the different UCI types on the scheduled PUSCH transmission in the second slot for transmission to the second TRP using the second spatial settings.

32. The non-transitory computer-readable storage medium of claim 31, wherein to determine if the timeline conditions are satisfied, the processing circuitry is further configured to: determine if the first symbol of the first repetition of the PUCCH and the scheduled PUSCH in the first slot is not before a symbol with a cyclic prefix (CP) starting after a last symbol of a physical downlink control channel (PDCCH) reception.

33. The non-transitory computer-readable storage medium of claim 32, wherein when the timeline conditions are satisfied and the UCI of the different UCI types is multiplexed on the scheduled PUSCH transmission in the first slot and multiplexed on the scheduled PUSCH transmission in the second slot, the processing circuitry is configured to cause the UE to refrain from transmitting the first and second repetitions of the PUCCH.

34. The non-transitory computer-readable storage medium of claim 32, wherein the first spatial settings correspond to a first TX beam transmitted by the UE to the first TRP and the second spatial settings correspond to a second TX beam transmitted by the UE to the second TRP.

35. The non-transitory computer-readable storage medium of claim 32, wherein the scheduled PUSCH transmission in the first slot and the scheduled PUSCH transmission in the second slot comprise two PUSCH repetitions carrying aperiodic channel state information (A-CSI).

36. The non-transitory computer-readable storage medium of claim 35, wherein the two PUSCH repetitions comprise M-TRP PUSCH repetition Type A.

37. The non-transitory computer-readable storage medium of claim 32, wherein when the UE is configured to multiplex the different UCI types in one PUCCH and when the second repetition of the PUCCH overlaps in the second slot with a scheduled PUSCH transmission in the second slot the processing circuitry is further configured to:
determine if the timeline conditions are also satisfied with respect to a first symbol of the second repetition of the PUCCH and the scheduled PUSCH in the second slot.

38. The non-transitory computer-readable storage medium of claim 37, wherein when the timeline conditions are also satisfied, the processing circuitry is configured to:
multiplex the UCI of the different UCI types on the scheduled PUSCH transmission in the first slot for transmission to the first TRP using the first spatial settings; and
multiplex the UCI of the different UCI types on the scheduled PUSCH transmission in the second slot for transmission to the second TRP using the second spatial settings.

39. An apparatus for gNode B (gNB) configured for operation in a fifth-generation (5G) new radio (NR) network, the apparatus comprising: processing circuitry; and memory, wherein for a User Equipment (UE) that supports multi-Transmission-Reception Point (M-TRP) physical uplink control channel (PUCCH) repetition, the processing circuitry is configured to:
encode a downlink control information (DCI) for transmission to the UE, the DCI to activate M-TRP PUCCH repetition with transmit (TX) beam cycling,
wherein the M-TRP PUCCH repetition with TX beam cycling comprises:
a first repetition of a PUCCH for carrying uplink control information (UCI) for transmission in a first slot to a first TRP using a first spatial setting; and
a second repetition of the PUCCH for carrying the UCI for transmission in a second slot to a second TRP using a second spatial setting,
wherein for UCI of different UCI types when the UE is configured to multiplex different UCI types in one PUCCH and when the first repetition of the PUCCH overlaps in the first slot with a scheduled physical uplink shared channel (PUSCH) transmission to the first TRP in the first slot, the processing circuitry is further configured to:
determine if timeline conditions are satisfied with respect to a first symbol of the first repetition of the PUCCH and the scheduled PUSCH in the first slot,
wherein when the timeline conditions are satisfied, the processing circuitry is configured to:
decode the scheduled PUSCH transmission comprising the UCI of the different UCI types multiplexed thereon received in the first slot received by the first TRP; and
decode the scheduled PUSCH transmission comprising the UCI of the different UCI types multiplexed thereon received in the second slot by the second TRP.

40. The apparatus of claim 39, wherein to determine if the timeline conditions are satisfied, the processing circuitry is further configured to:
determine if the first symbol of the first repetition of the PUCCH and the scheduled PUSCH in the first slot is not before a symbol with a cyclic prefix (CP) starting after a last symbol of a physical downlink control channel (PDCCH) reception.
